(19) United States
(12) Patent Application Publication
(10) Pub. No.: US 2025/0316965 A1
(43) Pub. Date: Oct. 9, 2025

(54) ELECTRICAL ENCLOSURE FOR JOINTS AND TERMINATIONS

(71) Applicant: Schneider Electric Industries SAS, Rueil-Malmaison (FR)

(72) Inventors: Patrick Comtois, Saint-Ismier (FR); Régis Perrocheau, Laval (FR); Santos Guinda, Guichainville (FR)

(73) Assignee: Schneider Electric Industries SAS, Rueil-Malmaison (FR)

(21) Appl. No.: 18/872,970

(22) PCT Filed: Jun. 9, 2023
(86) PCT No.: PCT/EP2023/065484

§ 371 Date: Dec. 9, 2024

(30) Foreign Application Priority Data
Jun. 10, 2022 (FR) FR2205609

(51) Int. Cl. H02B 1/36; H02B 11/10; H02B 11/173

(52) U.S. Cl. CPC H02B 1/36; H02B 11/10; H02B 11/173

(57) ABSTRACT

An electrical cabinet supplies at least two electrical loads (14) and includes: electromechanical units (130), each supplying an electrical load and including an analysis device, a controlled switch and a magnetic type protection device protecting the electromechanical unit and the electrical load; and electronic units (30), each supplying an electrical load, including an analysis device and a controlled switch, and being devoid of a magnetic type protection device. The electrical cabinet includes two functional zones, a first of which receives at least one electromechanical unit, and a second of which receives at least two electronic units and a common protection device (60), separate from the electronic units, protecting all the electronic units in the second functional zone and the electrical loads connected to them. In addition, the first functional zone is adapted to accommodate at least two electronic units and a common protection device, and the second functional zone is adapted to accommodate at least one electromechanical unit.

The present invention relates to an electrical connection cabinet.

In the field of industrial electrical cabinets, it is known to install one or more control units in an electrical connection cabinet. These control units allow each one to connect the electrical cabinet to an item of electrical equipment and to control this item of electrical equipment, in particular by means of a contactor. It is also known to protect each control unit using a magnetic protection device, such as, for example, a magnetic circuit breaker, each magnetic protection device allowing electricity to be supplied to a control unit and to electrically protect this control unit and the electrical equipment connected to it. These magnetic protection devices are generally integrated directly into the control units. Such protection devices are inexpensive, so that the presence of one magnetic protection device per control unit does not represent a significant additional cost in the manufacture of the electrical cabinet. However, such magnetic protection devices are not very effective, and their cutoff time is relatively long, which can lead to damage to the control units when they are triggered, such as, for example, contactor welding.

It is also known to use, in industrial electrical cabinets, protection devices common to several control units, which are not integrated into the control units but arranged outside the control units. In general, a protection device is used to simultaneously protect several control units when it presents higher performance than a magnetic protection device, and therefore a larger footprint and costs more to manufacture than a magnetic protection device. An example of such a protection device is a hybrid type protection device, which combines the use of a semiconductor and an electromechanical switching device. Using the common protection device for several control units therefore allows both to accommodate the larger footprint of this type of protection device and to reduce the cost of protection per control unit.

US-A1-2015/0103472 and EP-A1-2557643 describe prior art control cabinets, and CA-A1-3124942 describes a prior art protection device.

In known industrial electrical cabinets, there is no architecture that allows both control units incorporating magnetic protection devices and control units protected by common protection devices for several control units to be arranged in the same electrical cabinet.

This problem is specifically addressed by the invention, which proposes an electrical connection cabinet able to accommodate various control units protected either by magnetic type protection devices, or by protection devices common to several control units.

To this end, the invention relates to an electrical connection cabinet, the electrical cabinet being configured to supply and control at least two electrical loads. According to the invention, the electrical cabinet comprises a plurality of control units, selected from among:
electromechanical units, each electromechanical unit being configured to supply and control an electrical load and comprising an electronic analysis device, a controlled switch configured to allow or interrupt the power supply to the electrical load, and a magnetic type protection device configured to protect the electromechanical unit and the electrical load against electrical faults,
electronic units, each electronic unit being configured to supply and control an electrical load, comprising an electronic analysis device and a controlled switch configured to allow or interrupt the supply of the electrical load and being devoid of a magnetic type protection device.

In addition, the electrical cabinet comprises at least two functional zones, from among:
a first functional zone receiving at least one electromechanical unit, and
a second functional zone receiving at least two electronic units and a common protection device configured to protect all the electronic units in the second functional zone and the electrical loads connected to them against electrical faults, the common protection device being separate from the electronic units.

Furthermore, the first functional zone is, in addition, able to receive at least two electronic units and a common protection device, and the second functional zone is, in addition, able to receive at least one electromechanical unit.

Thanks to the invention, it is possible to install, in the same functional zone of the electrical cabinet, electromechanical units protected by magnetic type protection devices, or even electronic units protected by common protection devices for these electronic units. The electrical cabinet is thus modular, and the control units are chosen from among electromechanical units and electronic units, depending on the nature of the electrical loads to be supplied and controlled.

According to advantageous, but not mandatory, aspects of the invention, the functional module incorporates one or more of the following features, taken in isolation or in any technically permissible combinations:
A width of each electromechanical unit is strictly greater than a width of each electronic unit, the widths being measured between two lateral walls of the control units, and in which, in the second functional zone, the common protection device extends over the entire height of the second functional zone and is arranged on one side of the electronic units, according to a longitudinal axis of the electrical cabinet.

Each control unit comprises a rear base, which carries electrical input connectors, configured to supply electrical power to the control unit when the control unit is mounted in the electrical cabinet, and electrical output connectors, configured to supply electrical power to the electrical load connected to the control unit when the control unit is mounted in the electrical cabinet. Furthermore, the rear base of the electromechanical units is identical to the rear base of the electronic units, a width of the rear base is identical to the width of the electronic units, and preferably each electromechanical unit further comprises an enlargement piece, arranged on one side of the rear base of the electromechanical unit, so that the sum of the width of the rear base and a width of the enlargement piece is equal to the width of the electromechanical units.

Each control unit is a control drawer, movable in the first or second functional zone between three main positions:
an operating position of the control drawer, in which the control drawer is configured to be connected to the electrical load and in which the control drawer is connected to a communication module of the electrical cabinet,
a test position of the control drawer, in which the control drawer is configured not to be connected to the electrical load and in which the control drawer is connected to the communication module, and
a disconnected position of the control drawer, in which the control drawer is configured not to be connected to the electrical load and in which the control drawer is not connected to the communication module.

Each control drawer comprises a lateral wall carrying a movable lateral contact configured to allow data exchange between the control drawer and the communication module, the movable lateral contact being fixed relative to the communication module when the control drawer is moved between its operating position and its test position, and in which the lateral wall and the movable lateral contact of the electromechanical units, on the one hand, and of the electronic units, on the other hand, are identical.

Each control drawer comprises a position detector, configured to detect whether the control drawer is in the operating position, in the test position or in the disconnected position, and a locking system, configured to lock the control drawer in the operating position or in the test position, and in which the position detector and the locking mechanism of the electromechanical units, on the one hand, and of the electronic units, on the other hand, are identical.

The magnetic type protection device of each electromechanical unit comprises an electromechanical relay, configured to cut off the power supply to the controlled switch of the electromechanical unit in the event of a short circuit occurring in the electrical load connected to the electromechanical unit, this cutoff taking place in a time greater than 5 ms.

The common protection device of the second functional zone is of the hybrid type and comprises:
a semiconductor, configured to detect a short-circuit occurring in an electrical load connected to one of the electronic units of the second functional zone, or at one of the electronic units, and
an electromechanical protection element, configured to cut off the power supply to the electronic units of the second functional zone, this cutoff taking place in a time of less than 500 μs after detection of the short-circuit.

A front part of each electromechanical unit presents a mechanical switch controlling the switching between an open state and a closed state of the magnetic type protection device of the electromechanical unit, configured to be actuated by a user, and in which a front face of the common protection device presents a mechanical switch controlling the switching between an open state and a closed state of the common protection device, configured to be actuated by a user.

The electrical cabinet comprises at least two functional modules, each functional module comprising:
either at least one electromechanical unit, or at least two electronic units,
if the functional module comprises electronic units, a common protection device,
a data bus section, connected to all the control units of the functional module,
as many connection modules as there are control units, each connection module being configured to connect an electrical load to a control unit,
as many input/output modules as there are control units, each input/output module being configured to connect the data bus section to a control unit and to the electrical load connected to this control unit, and to allow the exchange of operating data between said electrical load, on the one hand, and said control unit and the data bus section, on the other hand, and
a support structure, to which each control unit, data bus section, each connection module, each input/output module and, where applicable, the common protection device are fixed.

Furthermore, each functional zone receives a functional module, the data bus sections of all the functional modules are connected to each other and to a communication module of the control cabinet, and the data bus section, the connection modules and the input/output modules of the functional modules comprising one or more electromechanical units, on the one hand, and of the functional modules comprising one or more electronic units, on the other hand, are identical.

The invention will be better understood, and other advantages thereof will become clearer in light of the following description of an embodiment of an electrical connection cabinet in accordance with its principle, given by way of example only and made with reference to the appended drawings in which:

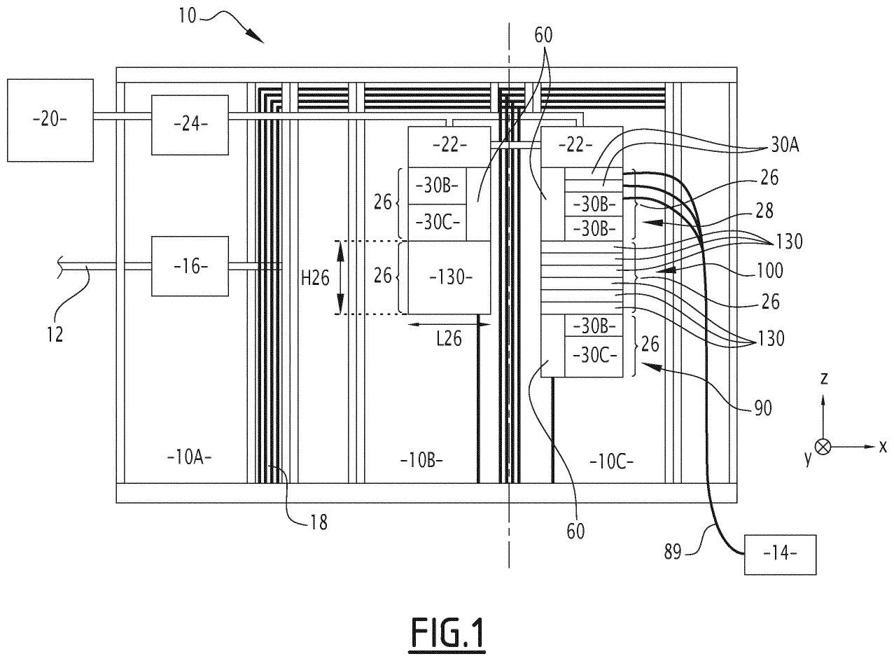

FIG. 1 is a schematic diagram of an electrical cabinet in accordance with the invention;

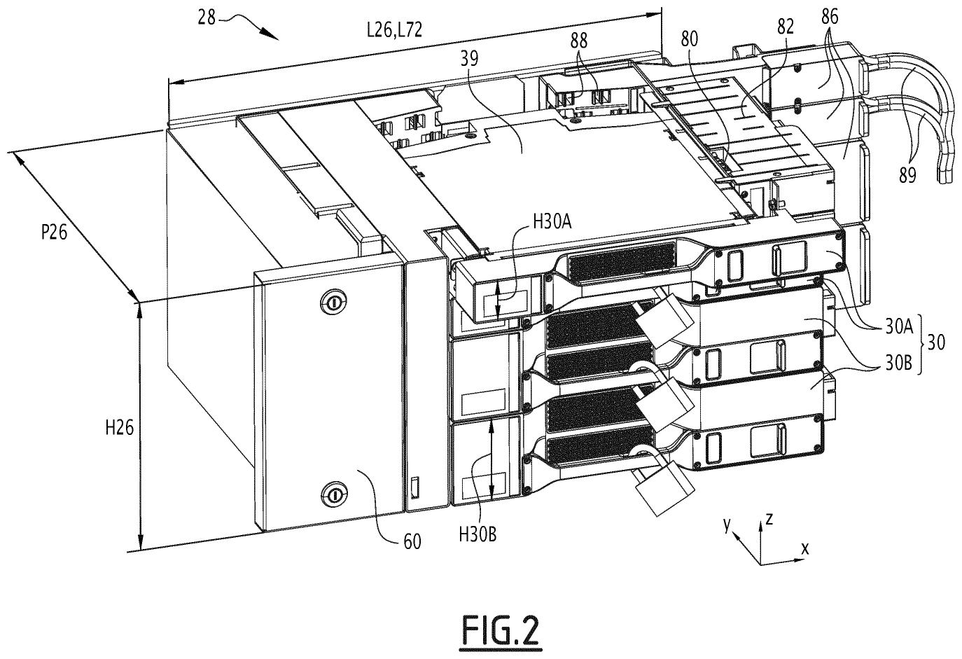

FIG. 2 is a perspective view of a first functional module belonging to the electrical cabinet of FIG. 1;

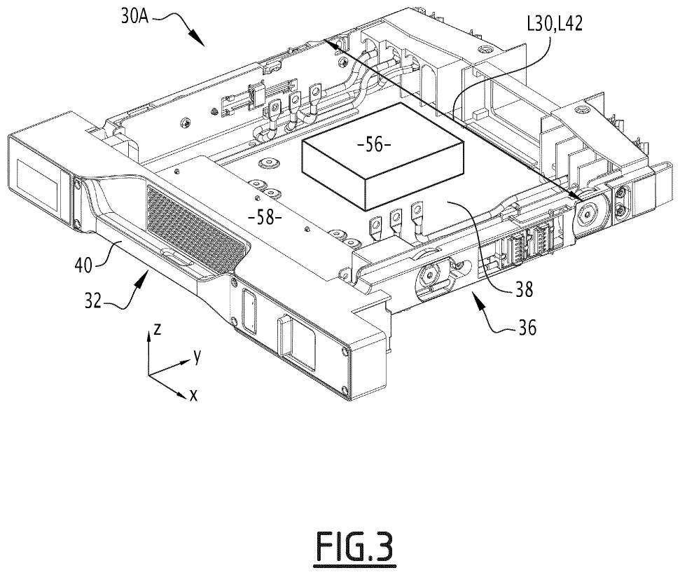

FIG. 3 is a perspective view of a drawer belonging to the functional module of FIG. 2;

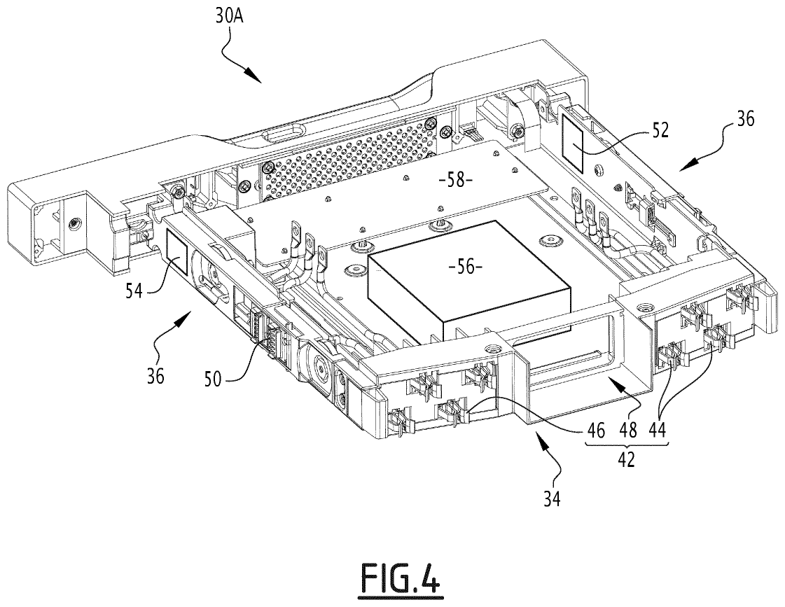

FIG. 4 is a perspective view of the drawer of FIG. 3, seen from a different angle;

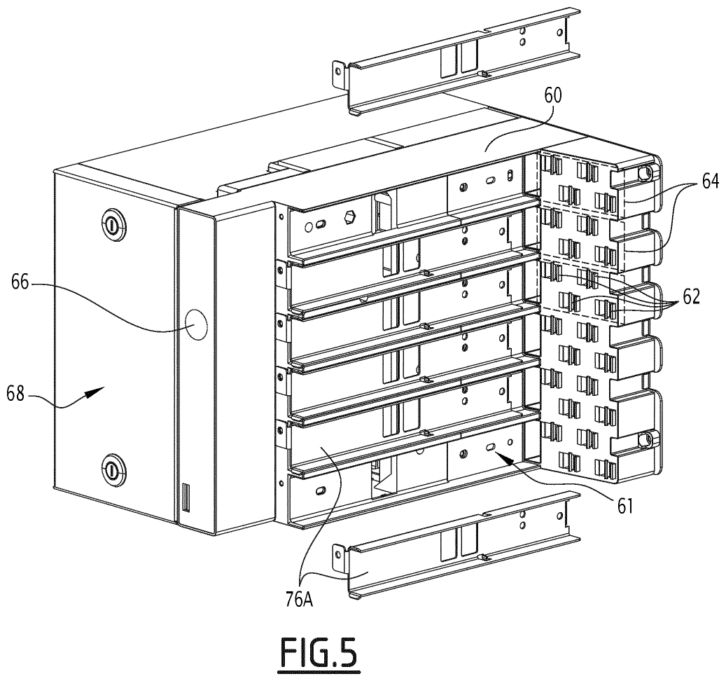

FIG. 5 is a perspective view of a hybrid type protection device belonging to the functional module of FIG. 2;

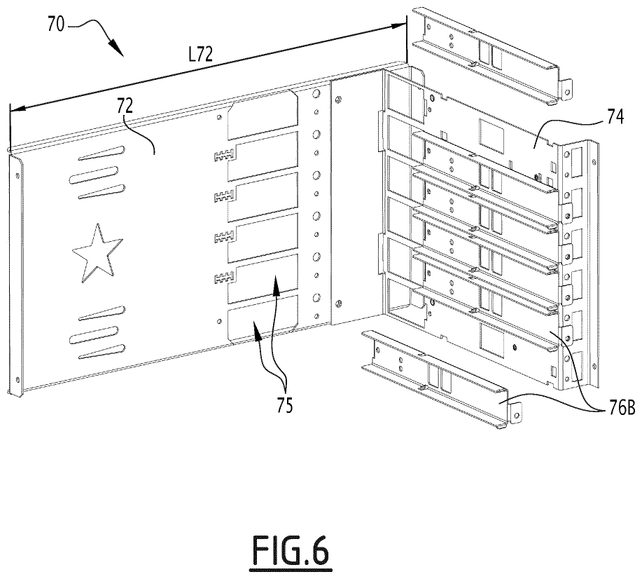

FIG. 6 is a perspective view of part of a structure belonging to the functional module of FIG. 2;

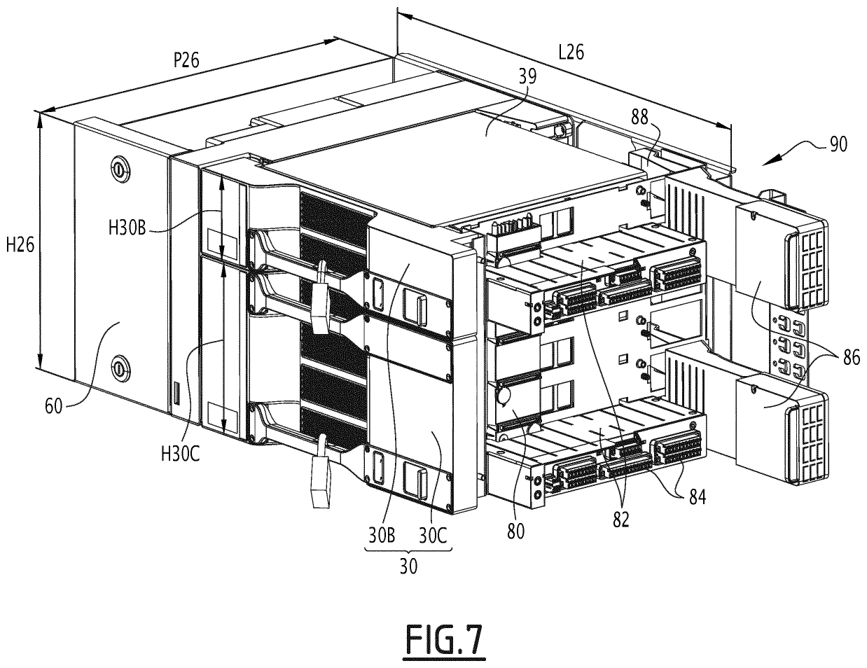

FIG. 7 is a perspective view of a second functional module belonging to the electrical cabinet of FIG. 1, seen from another angle;

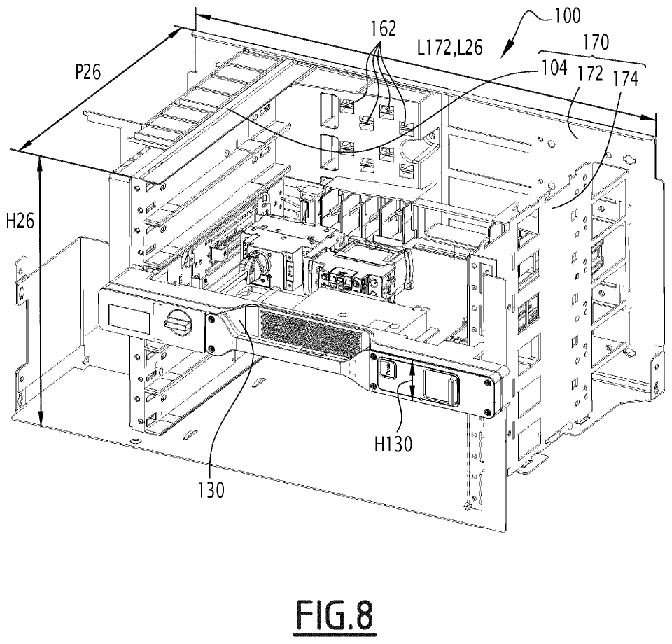

FIG. 8 is a perspective view of part of a third functional module belonging to the electrical cabinet of FIG. 1;

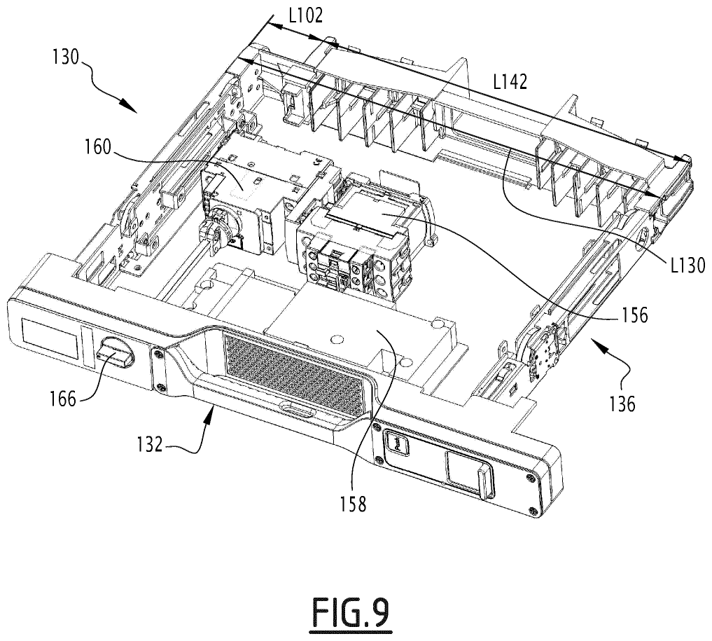

FIG. 9 is a perspective view of a drawer belonging to the third functional module of FIG. 8; and

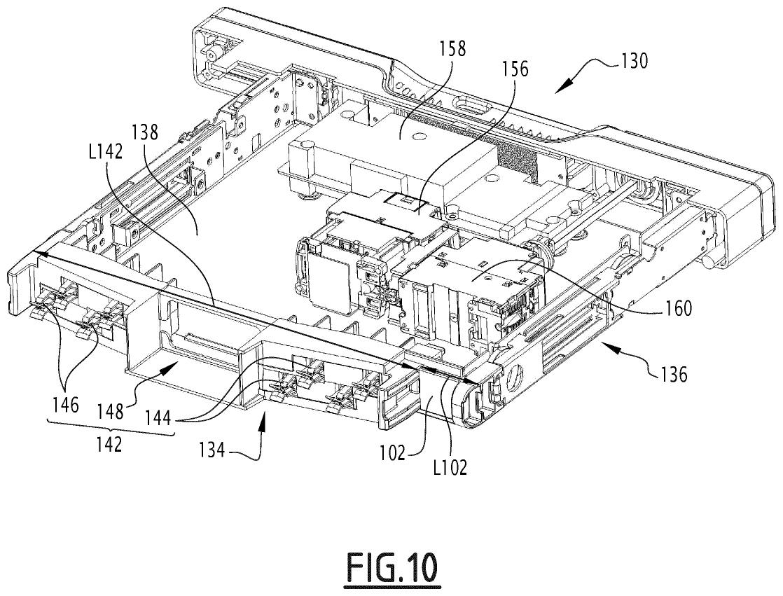

FIG. 10 is a perspective view of the drawer of FIG. 9, seen from a different angle.

An electrical cabinet 10 is represented in FIG. 1. This electrical cabinet is intended to be integrated into a partially represented electrical network. This electrical network comprises, on the one hand, upstream of the electrical cabinet 10, supply cables 12, for example, coming from a transformer substation, and, on the other hand, downstream of the electrical cabinet, one or more electrical loads 14.

The electrical cabinet 10 is a connection cabinet configured to connect the electrical loads 14 to the supply cables 12.

The electrical loads 14 may, for example, be electric motors, such as three-phase motors, electricity distribution networks, or even controllable electrical loads, such as batteries or solar panels.

In the installed configuration of the electrical cabinet 10, the cabinet rests on a horizontal surface, such as, for example, the floor of a building in which the electrical cabinet 10 is installed.

A longitudinal axis X of the electrical cabinet 10 is defined as being the axis of the largest dimension of the electrical cabinet 10, in practice its length, a transverse axis Y as being the axis of the smallest dimension of the electrical cabinet 10 and perpendicular to the axis X, in practice its depth, and a vertical axis Z as being the third axis of an orthogonal reference frame comprising the axes X and Y.

The orientation of the axes X, Y and Z are fixed to the orientation of the electrical cabinet 10. The orientation of the electrical cabinet 10 described in this present discussion corresponds to its installed configuration. It is therefore understood that the orientation of the axes X, Y and Z varies when the orientation of the control cabinet 10 varies. For example, the axis Z may not be vertical when the cabinet 10 is not in its installed configuration, for example when it is being transported. The terms “upper”, “lower” and “vertical” used in the following discussion refer to the axis Z.

In the installed configuration described here, the plane formed by the axes X and Y is horizontal and parallel to the horizontal surface on which the cabinet rests when in the installed configuration, while the axis Z is perpendicular to this horizontal surface. The term “horizontal” is used in the following to refer to any element contained in a plane parallel to the plane formed by the axes X and Y, in the installed configuration of the electrical cabinet 10. The terms “left” and “right” are used in relation to the axis X, and the terms “front” and “rear” are used in relation to the axis Y.

The relative positioning of the parts and their orientation described below are given by way of example only and are not limiting. Unless explicitly stated otherwise, they refer to the assembled and installed configuration of the electrical cabinet 10. Thus, when reference is made to the orientation of a part with respect to the axes X, Y and/or Z, it is understood to mean in the mounted configuration of the cabinet. When the cabinet 10 is stored, transported, unassembled or being assembled, among other examples, the orientation of the parts and their relative positioning may vary.

The supply cable 12 supplies the electrical cabinet 10 with a main power supply, preferably 400V three-phase with neutral, preferably at a frequency of 50 Hz. Advantageously, each phase and neutral of the supply cable 12 are connected to an input of a circuit breaker 16. Alternatively, the supply cable 12 delivers a supply with a voltage other than 400V, a supply with a frequency other than 50 Hz, a three-phase supply without neutral, or a single phase supply. The circuit breaker 16 then has a suitable number of inputs.

The electrical connection cabinet 10 comprises a busbar 18 comprising several feeders, in the example four feeders, each feeder being connected to an output of the circuit breaker 16. The busbar 18 allows the power supply from the power cable 12 to be distributed by the circuit breaker 16 to the various elements arranged in the electrical cabinet 10 allowing connection to the electrical loads 14.

Advantageously, the circuit breaker 16 is arranged in a supply column 10A of the electrical cabinet 10, and the elements of the electrical cabinet allowing connection to the electrical loads 14 are distributed in different connection columns, in the example, in two connection columns 10B and 10C. In an alternative, not shown, the electrical cabinet 10 comprises a number of connection columns other than two, for example one column or three connection columns.

The electrical cabinet 10 is controlled by an industrial computer 20. In practice, the industrial computer 20 comprises a computing unit, not represented, that executes software for managing the electrical cabinet 10.

Alternatively, the industrial computer 20 is replaced by a real time control and data acquisition system (SCADA) that monitors the operation of the electrical connection cabinet 10 or the computer is integrated into such a system.

Each connection column 10B, 10C comprises a communication module 22. As seen in FIG. 1, the communication module 22 is positioned near the upper end of each connection column 10B, 10C. In an alternative, not represented, of the invention, the communication module 22 of each connection column is positioned at the lower end of the column.

The communication module 22 of a connection column 10B, 10C allows all the information coming from this connection column to be centralized and to control the connection column.

The communication modules 22 communicate with the industrial computer 20 by means of communication cables or wireless links, on the one hand to transmit information on the operation of the connection columns 10B, 10C, and on the other hand to receive commands coming from the industrial computer and to be transmitted to the connection columns.

The communication module 22 of a connection column 10B, 10C therefore acts as an intermediary between the industrial computer 22 and this connection column and allows exchanges between the computer and the column to be centralized.

Advantageously, all the communication modules 22 are connected to a central switch 24, preferably arranged in the supply column 10A. This central switch 24 acts as an intermediary between the communication modules 22 and the industrial computer 20, in other words, that the information coming from the industrial computer, for example, the commands, is distributed between the communication modules 22 by the central switch 24, and that the information coming from the communication modules is aggregated by the central switch before being transmitted to the industrial computer. In an alternative, not represented, of the invention, the electrical cabinet 10 does not comprise a central switch 24, and the communication modules 22 are directly connected to the industrial computer 20.

Preferably, the internal communication cables connecting the industrial computer 20, the communication modules 22 and the central switch 24 are cables using the Ethernet protocol. Alternatively, the internal communication cables use another local network protocol, for example, MODBUS or PROFINET.

Generally speaking, a connection column 10B, 10C can be configured for several different uses:
A first configuration in which the connection column allows to connect electric motors, such as three phase motors. The connection column therefore allows to supply and control these electric motors. In this first configuration, the connection column is referred to as a “motor start column”.
A second configuration in which the connection column allows to connect to downstream electrical distribution circuits, such as for example, switchboards or electrical distribution cabinets. The connection column therefore allows to distribute power coming from the supply cables 12 toward several downstream circuits, and to protect these downstream circuits. In this second configuration, the connection column is referred to as a “power distribution column”.
A third configuration in which the connection column allows connection to controllable electrical loads, such as solar panels or batteries. The connection column therefore allows to supply these electrical circuits and to control them. In this third configuration, the connection column is referred to as a “load control column”.

In this example, connection columns 10A and 10B are motor start columns. Some elements mentioned below are described in the context of a motor start column, but their application is not limited exclusively to their use in a motor start column. Thus, some of the elements introduced below can also be applied to elements used in a power distribution column or a load control column.

In each connection column 10B, 10C, the electrical cabinet 10 comprises several functional zones 26, vertically juxtaposed, each functional zone accommodating one or more elements of the electrical cabinet allowing connection to the electrical loads 14.

All the functional zones 26 of the cabinet 10 have the same dimensions. “H26” is noted as the height of a functional zone 26, measured according to the vertical axis Z, “L26” is the width of a functional zone, measured according to the longitudinal axis X, and “P26” is the depth of a functional zone, measured according to the transverse axis Y.

In practice, all the elements of a functional zone 26 are grouped together in a functional module. Several functional modules belonging to the electrical cabinet 10 are described below. In the example, these functional modules are therefore modules intended for connection to electric motors, in other words, these functional modules are motor starter modules.

The configuration and architecture of these modules can be transposed to other configurations, as, for example, in the case of a power distribution column, where the functional module then corresponds to a distribution module that allows an electric current to be distributed toward one or more downstream circuits and protects these circuits, or in the case of a load control column, where the functional module then corresponds to a control module that allows to supply the electric loads and control them. Other uses are also conceivable.

In the example of FIG. 1, the electrical cabinet 10 comprises five functional zones 26, each of these zones receiving a functional module. Here, the electrical cabinet therefore comprises five functional modules. In practice, the connection column 10B comprises two functional modules and the connection column 10C comprises three functional modules.

With reference to FIG. 2, a first functional module 28 is now described. In the example, the functional module 28 is arranged in the upper part of the connection column 10C, between the communication module 22 and the other two functional modules of the connection column 10C.

The functional module 28 has a height, measured according to the vertical axis, identical to the height of the functional zone 26 in which it is mounted, in other words, a height equal to H26. Similarly, the depth of the functional module 28 is equal to P26.

The functional module 28 comprises four control units 30, juxtaposed vertically in the functional module, which allows each the electrical connection of an electrical load 14 to the electrical cabinet 10.

In the example represented, the control units 30 are control drawers which can therefore be installed in, and removed from, the functional module 28 simply and quickly, by a movement in translation according to the transverse axis Y. In an alternative, not represented, of the invention, the control units 30 are fixed cabinet units, which are assembled in the functional module 28 during cabinet installation, for example by screwing to the functional module.

Advantageously, when the control units 30 are drawers, each of these drawers is movable in the functional module 28 between three positions:
An operating position, in which the drawer is fully inserted into the functional module. This position corresponds to the normal operating position of the drawer, in other words, on the one hand, the drawer supplies electrical power to the electrical load 14 connected to it, and on the other hand, the drawer is connected to the communication module 22 of the connection column 10C. The three lower drawers are represented in operating position in FIG. 2.
A test position, in which the drawer is partially inserted into the functional module. This position corresponds to an intermediate position in which the drawer is operating, in other words, the elements it contains are supplied with electrical power and it is connected to the communication module 22, but the drawer is not supplying any electrical load 14. The upper drawer is represented in the test position in FIG. 2.
A disconnected position of the drawer, in which the drawer is partially or completely out of the functional module and in which the drawer is not supplied with electrical power, is not connected to the communication module and does not supply an electrical load 14.

Generally speaking, the control units 30 also allow control of the electrical loads 14 connected to them. This control, also referred to as piloting, consists of, for example, when the electrical load is a motor, in piloting this motor, in other words, starting it, stopping it and possibly controlling its speed, or again, when the electrical load is a distribution network, in supplying the voltage and current required for the correct operation of this distribution network.

In addition, the control units 30 also allow to monitor the electrical loads 14 connected to them. This monitoring consists, for example, in measuring the voltage and current delivered to the load 14, or in retrieving information coming from sensors such as position or rotation speed sensors, or temperature sensors when the load 14 is a motor.

Thus, each control unit 30 can have a role of connecting an electrical load 14, controlling this load and monitoring this load. However, according to the type of electrical load connected to a control unit, this control unit may not have the role of piloting this load or may not have the role of controlling the load.

In the example represented, the height of the control units 30 can take several defined values. The basic height of a control unit is defined as a unit height, denoted “U”. The height of a control unit can be equal to an integer multiple of this base height, up to a limit of six times the unit height U.

Thus, a control unit can occupy a height of 1U, 2U, 3U, 4U, 5U or 6U. Preferably, the unit height U is equal to 50 mm. Thus, a 6U-high control unit 138 would be 300 mm high.

Each functional module is configured to accommodate any technically permissible combination of control units 30, according to the height of these control units. For example, a functional module can accommodate:
six 1U high control units, as represented in the intermediate functional zone of column 10C in FIG. 1, or
three 2U high control units, or
one 6U high control unit, as represented in the lower functional area of column 10B in FIG. 1, or
one 2U high control unit and one 4U high control unit, as represented in the upper functional area of column 10B and in the lower functional area of column 10C in FIG. 1,
two 2U high control units and two 1U high control units, as represented in the upper functional area of column 10C in FIG. 1.

These examples are not limiting. Other distributions of the control units 30 within the functional zones are conceivable.

In the functional module 28 represented in FIG. 2, from among the control units 30, two control units 30A with a height H30A equal to 1U, and two control units 30B with a height H30B equal to 2U can be seen.

One of the two control units 30A can be seen in more detail with reference to FIGS. 3 and 4.

The control unit 30A is generally parallelepiped in shape and comprises a front part 32 and a rear part 34, which extend parallel to the axis X, two lateral walls 36, which extend parallel to the axis Y, a bottom 38 which extends between the front and rear parts and the lateral walls, and a cover 39, visible in FIG. 2 and not represented in FIGS. 3 and 4. In practice, the bottom 38 extends in a horizontal plane, perpendicular to the vertical axis Z.

The main width of the 30A control unit, noted “L30”, measured according to the axis X between the two lateral walls 36.

The control unit 30A is configured so that it can be moved between its operating, test and disconnected positions by means of a handle 40, provided in its front part 32, and provided to be maneuvered by an operator.

On its rear part 34, the control unit 30A comprises a rear base 42, which carries the input electrical connectors 44, the output electrical connectors 46 and, preferably, a ventilation hole 48 arranged between the input electrical connectors and the output electrical connectors. In the example, the control unit 30A comprises four electrical input connectors and four electrical output connectors. The width L42 of the rear base 42 is identical to the width L30 of the control unit 30A.

When the control unit 30A is in the operating position, in other words, when it is mounted in the electrical cabinet 10, the electrical input connectors 44 are provided to be electrically connected to the busbar 18, thus supplying electrical power to the control unit, and the electrical output connectors 46 are provided to supply power to the electrical load 14 connected to the control unit.

Advantageously, the control unit 30A comprises a movable lateral contact 50, arranged on one of the two lateral walls 36. The movable lateral contact connects the control unit 30A to the communication module 22 of the connection column 10C, in other words, it allows the exchange of data between the control unit and the communication module, or the supply of an auxiliary electrical voltage delivered by the communication module to the control unit. In practice, the movable lateral contact is mounted in a movable manner on one of the two lateral walls 36, so that, when the control unit is moved between its test and operating positions, the movable lateral contact moves, according to the axis Y, relative to the control unit, and is fixed relative to the communication module, thereby allowing the connection between the control unit and the communication module during movement of the control unit to be maintained.

Advantageously, the control unit 30A comprises a position detector 52, arranged on one of the two lateral walls 36, which allows to detect whether the control unit is in the operating position, in the test position or in the disconnected position. The position detector 52 comprises, for example, an actuator which cooperates with a structure of the functional module 28 to actuate the switches, or the sensors, when the control unit is in the test position or in the operating position.

Advantageously, the control unit 30A comprises a locking system 54, arranged on one of the two lateral walls 36, which allows the control unit to be locked in the test position or in the locked position, for example, by means of an electromagnetic lock. Thanks to the locking system 54, it is possible, for example, to prevent a user from switching the control unit 30A from its operating position toward its test position if an electrical load 14 is supplied by the control unit, or from its test position to its operating position if an electrical load 14 connected to the control unit is not in an operating state compatible with its start-up.

The control unit 30A comprises a controlled switch 56, represented schematically in FIGS. 3 and 4. The controlled switch is provided to allow or interrupt the power supply to the electrical load 14 connected to the control unit 30A, by electrically connecting, or electrically isolating, the electrical output connectors 46 to the electrical input connectors 44. The controlled switch 56 is, for example, a contactor. Thus, the state of the controlled switch 56 determines whether the electrical load connected to the control unit is in operation or stopped.

The control unit 30A comprises an electronic analysis device 58, which in the example, is an electronic card. In practice, the electronic analysis device 58 is connected to the communication module 22 of the connection column 10C, by means of the movable lateral contact 50. This device controls the state of the controlled switch 56, from commands coming from the communication module 22.

Advantageously, the electronic analysis device 58 also performs functions to monitor the operation of the control unit 30A and the electrical load 14 connected to it, for example, by monitoring the intensity of the current delivered to the electrical load 14. Data from these monitoring functions is transmitted to the communication module 22 of the connection column 10C.

Advantageously, the electronic analysis device 58 also ensures thermal protection for the control unit 30A. In other words, the electronic analysis device 58 acts as a thermal protection device. Preferably, this thermal protection is achieved electronically, the electronic analysis device 58 incorporating a current sensor per phase and a microprocessor executing an algorithm which analyzes the measured currents to detect signals representative of the presence of a thermal fault, such as, for example, an increase in current or an imbalance in the measured current between several phases. The electronic analysis device 58 is therefore also referred to as an electronic thermal analysis and protection device.

In practice, the control units 30B differ from the control unit 30A described above in that their height H30B is different, allowing to accommodate a controlled switch 56 having larger dimensions. The control units 30B thus comprise a rear part, two lateral walls and a bottom identical to those of the control unit 30A described above. The control units 30B also comprise a front part, with a handle. The height of this front part is equal to the height H30B. Thus, it is easy to adapt the height of a control unit, since only the cover and the front part need to be modified. It is particularly advantageous to be able to simply adapt the height of a control unit, as this allows to simply modify the dimensions of the controlled switch 56, in particular, as a function of the electrical power consumed by the electrical load 14 connected to this control unit, as the dimensions of a controlled switch depend on the power of the electrical current flowing through the controlled switch.

To ensure the electrical protection of the control units 30, particularly in the event of failure of the electrical loads connected to them, as, for example, a short circuit, the functional module 28 also comprises a protection device 60, best seen in FIG. 5. The protection device 60 is separate from the control units 30, in other words, it is located outside the control units it protects, within the same functional module 28.

Advantageously, the protection device 60 extends over the entire height of the functional module 28. In other words, the height of the protection device 60 is equal to H26. In practice, the protection device 60 is said to be “common”, as it is configured to electrically protect all the control units 30 of the functional module 28, in other words, the two units 30A and the two units 30B, as well as the electrical loads 14 which are connected to these control units. Thus, although the protection device 60 is able to protect a single control unit, it is particularly able to protect at least two control units. In addition, the protection device 60 is arranged, according to the longitudinal axis X, on one side of the control units, in the example of FIG. 2, to the left of the control units. Thus, a lateral wall 61 of the protection device 60 is facing the control units 30 when the functional module 28 is assembled.

In practice, the protection device 60 is electrically interposed between the busbar 18 and the controlled switch 56 of the control units 30. In other words, the protection device 60 is electrically connected on the one hand to the busbar and on the other hand to the controlled switch of each of the control units. The protection device 60 is able to be switched between an open state, in which the controlled switches 56 of the control units 30 are not supplied with electrical power, and a closed state, in which the controlled switches of the control units are supplied with electrical power. The connection of the protection device to the busbar is not described in detail here, but can be executed, for example, using electrical cables, busbars or suitable connectors.

The protection device 60 comprises several electrical output connectors 62, divided into groups, denoted 64. In the example, each group 64 comprises four electrical output connectors, and the protection device 60 comprises six groups 64. Each group 64 of the electrical output connectors 62 is provided to be connected to the electrical input connectors 44 of a control unit 30, thus allowing electrical connection between the protection device and the control unit.

In the example, since the functional module 28 comprises four control units 30, then four of the six groups 64 are connected to the electrical input connectors 44 of the control units 30, while the other two groups 64 are not used.

In practice, the groups 64 are used, or not, depending on the combination of control units 30 installed in the functional module 28.

The electrical output connectors 62 extend from the lateral wall 61 of the protection device 60 and are arranged behind the protection device.

The protection device 60 is of the hybrid type, in other words, it presents increased performance compared with a magnetic protection device, or it includes more functions than a magnetic protection device. In the example, the hybrid type protection device 60 comprises an electromechanical protection element associated with a semiconductor, the semiconductor being connected in parallel with the electromechanical protection element, and the hybrid type protection device also comprises a short circuit detection element. The hybrid protection device is configured to cut the power supply to all the control units 30 in the event of a short circuit in an electrical load 14 connected to one of the control units, in other words, to switch the protection device to the open state. Cutting off the power supply to the control units thus cuts off the power supply to the electrical loads 14 connected to them, and allows to interrupt the electrical fault, thus protecting the control units and the electrical loads. Under normal circumstances, the power supply to the control units 30 passes through the electromechanical protection element and not through the semiconductor.

In practice, in the example, the short circuit detection element is able to detect a short circuit in a time of less than 50 μs after the short circuit has occurred. When a short circuit occurs on an electrical load, the short circuit detection element detects this short circuit and causes the electromechanical protection element to open, this opening taking place in a time of less than 500 μs after detection of the short circuit. The power supply to the control units 30 then passes through the semiconductor. The semiconductor then interrupts the power supply, with a cutoff voltage higher than the cutoff voltage of the electromechanical protection element, for example twice as high. This higher cutoff voltage allows the power supply to the control units 30 to be interrupted more quickly.

Thanks to the combined use of an electromechanical protection element, a semiconductor and a short circuit detection element, this disconnection takes place in less than 500 μs after detection of the short circuit, particularly as the semiconductor allows rapid disconnection of the power supply. This rapid cutoff allows to limit the damage caused by the electrical fault. In particular, when the electrical fault is a short circuit, the thermal energy generated by this short circuit is minimized, which allows to minimize heating of the control units 30.

In addition, once the power supply to the control units has been interrupted, the semiconductor of the protection device 60 is able to detect the source of the electrical fault, in other words, to which control unit 30 the faulty electrical load 14 is connected, and then isolate this control unit to restore power to the control units connected to the nonfaulty non-defective electrical loads. In other words, after the power supply to all the control units has been interrupted, the protection device 60 only keeps the power supply to the faulty electrical load interrupted, which is particularly advantageous for limiting the interruption of operation of the other electrical loads connected to the control units of the functional module 28. The protection device 60 is therefore able to be in a partially open or partially closed state, in other words, open for some control units 30 and closed for other control units of the functional module 28. Advantageously, the time between the initial switching to the open state, linked to the detection of a fault on an electrical load, and the switching to the partially closed state restoring the power supply to the other electrical loads connected to the same functional module, is sufficiently short, of the order of 100 ms, so that the operation of the other electrical loads is not interrupted.

The protection device 60 also comprises a mechanical switch 66 arranged on a front panel 68 of the protection device. The mechanical switch 66 is provided to be actuated by a user and allows the protection device 60 to be switched between its open and closed states.

The functional module 28 comprises a support structure 70, partially visible in FIG. 6. Here, the support structure 70 comprises a bottom 72 and a lateral wall 74, and, preferably, a lower plate and an upper plate, which are horizontal and not represented in the figures. When the functional module 28 is assembled, the protection device 60 is fixed to the support structure 70, and in particular to the bottom 72, and the lateral wall 74 of the support structure 70 is parallel to the lateral wall 61 of the protection device.

Advantageously, the bottom 72 presents a width L72 equal to the width L26 of the functional zones 26. Thus, the support structure 70 is able to be received in the functional zones.

Advantageously, openings 75 are arranged in the bottom 72. When the control units 30 are mounted in the functional module 28, the ventilation hole 48 in the rear base 42 of each control unit 30 faces an opening 75, allowing ventilation of the control unit interior.

The functional module 28 also comprises rails 76A and 76B, preferably six rails 76A and six rails 76B, which extend according to the transverse axis Y. The rails 76A are arranged on the lateral wall 61 of the protection device 60 and the rails 76B are arranged on the lateral wall 74 of the support structure 70, so that one rail 76B is arranged facing each rail 76A. The rails 76A and 76B thus form pairs of rails, in the example six pairs of rails.

In FIG. 5, the upper rail 76A and the lower rail 76A are shown in exploded view, in other words, these rails are removed from the lateral wall 61. Similarly, in FIG. 6, the upper rail 76B and the lower rail 76B are shown in exploded view.

The rails 76A and 76B allow the control units 30 to be mounted in the functional module 28, and advantageously, when the control units are drawers, allow them to be moved in the functional module between their operating, test and disconnected positions.

Advantageously, the functional module 28 comprises a data bus section 80 which extends vertically. This data module section is partially visible in FIG. 2. A comparable data module section 80 is more clearly visible in FIG. 7, which represents another functional module described below.

When the electrical cabinet 10 is assembled, the data bus sections 80 of all the functional modules of a connection column are connected to each other, and the data bus section of the uppermost functional module is additionally connected to the communication module 22 of this connection column, thus allowing the exchange of data between each functional module and the communication module. In other words, a functional module is connected to the communication module of its connection column by means of the data bus section of this functional module.

In addition, preferably, the data bus sections 80 of a connection column also allow the functional modules of this connection column to be supplied with an auxiliary electrical voltage delivered by the communication module 22 of this connection column. This auxiliary voltage is, for example, a DC or AC voltage of 12V, 24V, 48V, 110V or 230V. This auxiliary voltage allows the functional module 28 to operate, for example by powering the electronic card 58 or the locking system 54 of each control unit 30.

In practice, the auxiliary voltage is supplied to the functional module 28 and its control units 30 irrespective of the state of the protection device 60, in other words, whether the protection device is in the open or closed state. Thus, even if the power supply to the control units 30 and thus to the electrical loads 14 is cut off by the protection device, the control units, for example the electronic card 58 or the locking system 54, remain operational.

Advantageously, the functional module 28 comprises input/output modules 82, in practice as many input/output modules as control units 30, in other words, in the example, four input/output modules. In practice, each input/output module 82 is associated with a control unit 30.

Each input/output module 82 comprises a connection interface, not visible in the figures. When the control unit associated with the input/output module is mounted in the operating module 28, the connection interface is connected to the movable lateral contact 50 of the control unit.

Each input/output module 82 also comprises a connector, not visible in the figures, which is connected to the data bus section 80 when the function module 28 is assembled.

Thus, the input/output module associated with a control unit 30 allows the control unit to be connected to the data bus section, by means of the communication interface and the connector. This connection allows data to be exchanged between the control unit and the communication module, and/or to supply the control unit with the auxiliary voltage supplied by the communication module.

Advantageously, each control unit 30 also comprises a first wireless communication card, not represented, which communicates with a second wireless communication card, also not represented, belonging to the input/output module 82 associated with this control unit when the control unit is mounted in the functional module 28. The first and second wireless communication cards allow data exchange between the control unit and the input/output module. When such wireless communication cards are used, the movable lateral contact 50 is preferably used only for supplying the control unit with the auxiliary voltage delivered by the communication module.

Each input/output module 82 also comprises connection terminals, not represented, for the functional module 28. Comparable connection terminals can be seen in FIG. 7, with reference 84, for the second functional module. The connection terminals allow the input/output module 82 associated with a control unit 30 to be connected to the electrical load 14 connected to this control unit. In practice, the connection terminals are provided to deliver the auxiliary voltage supplied by the communication module 22 to the electrical load 14, this auxiliary voltage being used, for example, to supply auxiliary functions of the electrical load, such as operating sensors. The connection terminals are also provided to allow the exchange of data between, on the one hand, the electrical load 14 and, on the other hand, the data bus section 80 and the control unit 30, this data can, for example, be signals coming from the operating sensors or an emergency stop signal.

Preferably, the input/output modules 82 extend partially outside the functional zone 26 in which the functional module 28 is installed, so as to facilitate the connection of electrical cables to the connection terminal inside the connection column 10C.

Advantageously, the functional module 28 comprises connection modules 86, in practice as many connection modules as there are control units 30, in other words, in the example, four connection modules. In practice, each connection module 86 is associated with a control unit 30.

Each connection module 86 is connected, on the one hand, to its associated control unit 30 and, on the other hand, to the electrical load 14 associated with the control unit. In other words, each connection module 86 allows an electrical load 14 to be connected to and powered by a control unit 30.

Each connection module 86 comprises electrical connectors 88, in the example four electrical connectors 88. These electrical connectors are complementary to the electrical output connectors 46 of the control units 30. Thus, the electrical connectors 88 of a connection module 86 are provided to be connected to the electrical output connectors 46 of the control unit 30 associated with this connection module, thus allowing the electrical connection between the connection module and the control unit.

Each connection module 86 comprises internal conductors, not visible in the figures, which connect the electrical connectors 88 to the electrical cables 89, these electrical cables allow, in practice, the connection module to be connected to an electrical load 14. In practice, the sizing of these internal conductors depends on the electrical power consumed by the electrical load 14, and therefore on the size of the control unit 30 to which the electrical load is connected. Thus, the size of a connection module 86 is adapted to the height of the associated control unit 30. In the example, each connection module 86 of the functional module 28 is chosen from among three connection modules of different dimensions, with heights of 1U, 2U or 3U.

Preferably, the connection modules 86 extend partially outside the functional zone 26 in which the functional module 28 is installed, so as to facilitate the connection of electrical cables 89 inside the connection column 10C.

An electrical load 14 is therefore supplied by means of the circuit breaker 16, the busbar 18, the protection device 60, a control unit 30, then the connection module 86 associated with this control unit.

A second functional module, noted 90, is represented in FIG. 7. This functional module 90 also belongs to the connection column 10C. It is arranged in the functional zone 26 located at the bottom of the connection column 10C, underneath the other two functional zones of the connection column.

The functional module 90 differs from the functional module 28 described above in that it comprises two control units 30, instead of four control units. Among these two units there is a control unit 30B with a height of 2U, and a control unit 30C with a height H30C equal to 4U.

Consequently, the functional module 90 comprises two input/output modules 82, each associated with one of the two control units, and two connection modules 86, each associated with one of the two control units.

The protection device 60, the support structure 70, the data bus section 80, the input/output modules 82 and the connection modules 86 of the functional module 90 operate in the same way as the same elements of the functional module 28.

Another functional module, noted 100, is represented shown in part in FIG. 8. This functional module 100 also belongs to the connection column 10C. In the example, it is arranged between the functional modules 28 and 90, in other words, in the intermediate functional zone of the column.

The functional module 100 comprises several control units 130, only one of which is represented in FIG. 8. This unit is also represented on its own in FIGS. 9 and 10.

Like the control units 30, the control unit 130 here is a control drawer, which is movable in the functional module 100 between an operating position, a test position and a disconnected position. In FIG. 8, the control unit 10 is represented in the operating position.

The control unit 130 has the same function as the control units 30 of the functional modules 28 and 90, namely, to allow the electrical connection of an electrical load 14 to the control cabinet 10, as well as control and/or monitoring of this electrical load.

Thus, the control unit 130 comprises a front part 132, a rear part 134, lateral walls 136, a bottom 138 and a cover, not represented, in a similar way to the control units 30.

In practice, the lateral walls 136 are identical to the lateral walls 36 of the control units 30. In particular, the control unit 130 comprises a movable lateral contact, a position detector and a locking system, not represented in the figures, identical to those of the control units 30.

The control unit 130 also comprises a controlled switch 156 and an electronic analysis device 158, which function in the same way as the controlled switch 56 and the electronic analysis device 58.

In the example, the height H130 of each control unit 130 is equal to 1U, in other words, equal to the height H30A of the control units 30A. In practice, the height of the control units 130 is adapted to the dimensions of the controlled switch 156 and may occupy a height of 1U, 2U, 3U, 4U, 5U or 6U.

To ensure electrical protection of the control unit 130, in particular in the event of failure of the electrical load 14 connected to it, for example, a short circuit, the control unit 130 also incorporates a protection device 160.

The protection device 160 is internal to, in other words, integrated in, the control unit 130. The control units 130 are identical. Thus, within the functional module 100, all the control units 130 incorporate a protection device 160. In other words, unlike the protection device 60 which protects, in a common manner, all the control units 30 of a functional module 28 or 90, in the functional module 100, each control unit 130 has its own dedicated electrical protection, in the form of a protection device 160. Thus, each control unit 130 of the functional module 100 is independent.

The protection device 160 is provided to switch between an open state, in which the controlled switch 156 is not supplied with electrical power, and a closed state, in which the controlled switch is supplied with electrical power. Thus, the protection device 160 is connected to the input of the controlled switch 156.

The protection device 160 is of the magnetic type, in other words, the protection device 160 is a magnetic protection device comprising mechanical parts configured to cut the power supply to the controlled switch 156 of the control unit 130 in the event of a short circuit occurring in the electrical load connected to the control unit. These mechanical parts are, for example, an electromechanical cutoff device, such as an electromechanical relay comprising an electromagnet equipped with a moving part mechanically linked with a switch allowing the power supply to the controlled switch 156 to be cut off. In practice, the current is cut off by a magnetic type protection device in a time greater than 5 ms after detection of the short circuit, in other words, the cutoff time of a magnetic type protection device is, at best, ten times longer than the cutoff time of a hybrid type protection device.

It is therefore understood that the functional module 100 does not include a protection device separate from the control units 130.

To accommodate the presence of the protection device 160, a main width of the control unit 130, noted L130 and measured according to the axis X between the two lateral walls 136, is strictly greater than the main width L30 of the control units 30. Indeed, since the control unit 130 comprises the same elements as the control units 30, and also integrates the protection device 160, its dimensions must be greater so that sufficient space for the installation of the protection device 160 is available inside the control unit 130. Thus, the front part 132 is longer than the front part 32, and the rear part 134 is also longer than the rear part 34. In practice, the front part 132 and the rear part 134 can be lengthened, compared with the front part 32 and the rear part 34, because the space occupied by the protection device 60 in the functional modules 28 and 90 is freed up in the functional module 100, and therefore available for the control units 130, the protection device 160 being integrated into the control unit 130.

In practice, the control unit 130 comprises, at its rear part 134, a rear base 142, which is identical to the rear base 42 of the control units 30. Thus, the rear base 142 carries the electrical input connectors 144, the electrical output connectors 146 and, preferably, a ventilation hole 148, which function like the electrical connectors 44 and 46 and the ventilation hole 48.

In the control unit 130, the input electrical connectors 144 are connected to the input of the protection device 160 and the output electrical connectors 146 are connected to the output of the controlled switch 156.

Advantageously, the control unit 130 also comprises, at its rear part 134, an enlargement piece 102, which is arranged on one side of the rear base 134, according to the longitudinal axis X. The enlargement piece 102 is provided so that the sum of a width L102 of this piece and a width L142 of the rear base is equal to the width L130 of the control unit.

In an alternative, not represented, of the invention, the control unit 130 does not comprise an enlargement piece 102 and the rear base 142 is not identical to the rear base 42, its width L142 being increased relative to that of the rear base 42, so as to be equal to the width L130.

At its front part 132, the control unit 130 also comprises a mechanical switch 166, provided to be actuated by a user, and allowing the protection device 160 to be switched between its open and closed states.

The functional module 100 also comprises a support structure 170. This support structure comprises a bottom 172 and a first lateral wall 174, which are identical to the bottom 72 and the lateral wall 74 of the support structure 70, and further comprises a second lateral wall 104, which extends parallel to the first lateral wall 174. In particular, a width L172 of the bottom 172 is equal to the width L72 of the bottom 72.

The functional module 100 also comprises first rails and second rails, preferably six first rails and six second rails, which extend according to the transverse axis Y, and which are not represented in FIG. 8. The first rails are similar to the rails 76A of the functional module 28 and the second rails are similar to the rails 76B of the functional module 28. The first rails are arranged on the second lateral wall 104 of the support structure 170 and the second rails are arranged on the first lateral wall 174 of the support structure 170, so that a second rail is arranged facing each first rail. The first and second rails thus form pairs of rails, in the example, six pairs of rails, and allow the control unit 130 to be mounted and moved in the functional module 100.

It is also understood that, in comparison with the functional modules 28 and 90, the functional module 100 is able to compensate for the absence of the protection device 60, the control units 130 being enlarged and the support structure 170 being completed with the second lateral wall 104 so that the first rails can be arranged there.

In addition, the support structure 170 carries the electrical connectors 162, which are provided to be connected to the electrical input connectors 144 of the control unit 130. In practice, the support structure 170 carries several groups of electrical connectors 162, in the example, six groups, so that each group allows connection to the electrical input connectors of a control unit. The electrical connectors 162 are also connected to the busbar 18 of the electrical cabinet 10, by means, not represented, such as electrical cables, busbars or suitable connectors.

Thus, the protection device 160 is supplied with electrical power from the busbar 18 by means of the electrical connectors 162.

The functional module 100 also comprises a data bus section and as many input/output modules and connection modules as there are control units 130, which are not represented in FIG. 8 and which are identical to the data bus section 80, the input/output modules 82 and the connection modules 86 of the functional modules 28 and 90.

Thus, between a functional module 100, on the one hand, and a functional module 28 or 90, on the other, only the presence or absence of a protection device 60, the control units and part of the support structure of the functional module differ.

In practice, the dimensions of the functional module 100 are similar to the dimensions of the functional modules 28 and 90, so that each module can be installed in all the functional zones 26 of the connection columns 10B and 10C, since all the functional zones have the same dimensions. In other words, the height of the functional module 100 is equal to H26 and the depth of the functional module 100 is equal to P26.

It is therefore possible to choose, within the electrical cabinet 10, how many functional modules comprise a protection device 60 common for all the control units 30 of these functional modules, and how many functional modules comprise control units 130 each embedding their own protection device 160.

In the example represented, a connection column 10B, 10C includes up to five functional zones 26, therefore, up to five functional modules each able to accommodate between one and six control units 30 or 130, in other words, one connection column includes up to thirty control units 30 or 130, and therefore allows the connection of a maximum of thirty electrical loads 14. A connection column 10B, 10C is modular, in other words, it is possible to install as many functional modules and control units as desired.

Alternatively, a connection column 10B, 10C can include more than five functional zones and five functional modules, for example if the height of a functional zone and a functional module is reduced, or if the height of the connection column is increased.

In the case of functional modules 28 and 90, the control units 30 do not comprise magnetic protection and disconnection functions, which are ensured by the protection device 60. These control units 30 then only incorporate an element for controlling the electrical load 14, namely the controlled switch 56, and the evaluation electronics, namely the electronic board 58. The control units 30 are thus also referred to as “electronic units”.

In the case of the functional module 100, the control units 130 also incorporate the magnetic protection and disconnection functions ensured by the incorporated protection device 160 and are, therefore, also referred to as “electromechanical units”, since the protection device 160 operates mechanically.

It is advantageous to have both electronic and electromechanical units in the same control cabinet 10, as the two types of unit do not present the same advantages and disadvantages.

In particular, the electronic units, combined with hybrid type protection devices, present the advantage of being particularly effective in ensuring reliable operation of the electrical loads connected to them. Indeed, the very short cutoff time of the hybrid type protection devices eliminates the risk of damage to electronic units, and in particular their controlled switches, and electrical loads. However, hybrid protection devices are generally expensive. Thus, electronic units, combined with hybrid type protection devices, are preferably used to supply and protect electrical loads which are themselves expensive, or the correct operation of which is critical, in order to reduce the risk of failure of the electrical load. In addition, it is particularly advantageous to mutualize the protection of a hybrid type protection device to several control units, in the example, up to six units, so as to reduce the cost of protection per unit.

Conversely, electromechanical units present the advantage of being inexpensive to manufacture, but the cut off time of magnetic type protection devices 160 means that these protection devices provide less protection than hybrid type protection devices. Thus, electromechanical units are preferably used to supply and protect low cost electrical loads or loads the correct operation of which is not critical.

Thanks to the modularity of the electrical cabinet 10, it is easy to adapt the number of electromechanical units, and the number of electronic units installed in the functional zones 26 depending on the precise requirements of the electrical installation in which the electrical cabinet is integrated, in particular the number and type of electrical loads 14.

In addition, the functional modules 28, 90, on the one hand, and the functional module 100, on the other, use a large number of identical parts in common, namely the base and first lateral wall of the support structure, the data bus section and the input/output and connection modules. This common use of identical pieces is particularly advantageous for reducing the manufacturing cost of the functional modules, and therefore of the control cabinet 10.

Similarly, the control units 30 and the control units 130 also use a large number of identical parts, namely their rear base, their lateral walls, the various systems carried by their lateral walls, such as the movable lateral contact, the position detector and the locking system, and, preferably, their electronic card and their controlled switch. This use of identical parts is particularly advantageous for reducing the manufacturing cost of the control units, and therefore of the electrical cabinet 10.

In an alternative, not represented, of the invention, the functional modules 28, 90 and/or 100 do not comprise a connection module. In such an alternative, the connection of the electrical loads 14 to the control units 30, 130 takes place directly at the control units, for example using electrical cables.

In an alternative, not represented, of the invention, the functional modules 28, 90 and/or 100 do not comprise an input/output module nor a data bus section. In such an alternative, the connection between, on the one hand, the control units 30, 130, and, on the other hand, the communication module 22 and the electrical loads 14, for the exchange of data and/or the supply of auxiliary electrical voltage, is performed directly by means of electrical cables, at the control units.

In an alternative, not represented, of the invention, the functional modules 28, 90 and/or 100 do not comprise a support structure 70, 170, and the other elements of the functional modules, such as, for example, the rails, the hybrid type protection devices, the data bus section and the input/output and connection modules, are then fixed directly to a framework of the electrical cabinet 10.

In an alternative, not represented, of the invention, the electrical cabinet 10 does not comprise functional modules, and the electronic units associated with the hybrid type protection devices, or the electromechanical units are mounted directly in the functional zones 26, each functional zone receiving either electronic units or electromechanical units.

Any feature described for one embodiment or alternative in the foregoing may be implemented for the other embodiments and alternatives described above, insofar as technically feasible.

1. An electrical connection cabinet, the electrical cabinet being configured to supply and control at least two electrical loads, wherein:
the electrical cabinet comprises a plurality of control units, selected from among:
electromechanical units, each electromechanical unit being configured to supply and control an electrical load, and comprising an electronic analysis device, a controlled switch configured to allow or interrupt the supply to the electrical load, and a magnetic type protection device configured to protect the electromechanical unit and the electrical load against electrical faults, and
electronic units, each electronic unit being configured to supply and control an electrical load, and comprising an electronic analysis device a controlled switch configured to allow or interrupt the supply to the electrical load and being devoid of a magnetic type protection device,
the electrical cabinet comprises at least two functional zones, from among which:
a first functional zone accommodates at least one electromechanical unit, and
a second functional zone accommodates at least two electronic units, and a common protection device configured to protect all the electronic units in the second functional zone and the electrical loads connected to them against electrical faults, the common protection device being separate from the electronic units,
the first functional zone is, in addition, adapted to accommodate at least two electronic units and a common protection device, and
the second functional zone is, in addition, adapted to accommodate at least one electromechanical unit.

2. The electrical connection cabinet according to claim 1, wherein a width of each electromechanical unit is strictly greater than a width of each electronic unit, said widths being measured between two lateral walls of the control units, and wherein, in the second functional zone, the common protection device extends over the entire height of the second functional zone and is arranged on one side of the electronic units, according to a longitudinal axis of the control cabinet.

3. The electrical connection cabinet according to claim 2, wherein:
each control unit comprises a rear base, which carries the electrical input connectors, configured to supply electrical power to the control unit when the control unit is mounted in the electrical cabinet, and electrical output connectors, configured to supply electrical power to the electrical load connected to the control unit when the control unit is mounted in the electrical cabinet,
the rear base of the electromechanical units is identical to the rear base of the electronic units, and
a width of the rear base of the electromechanical units and of the electronic units is identical to the width of the electronic units.

4. The electrical connection cabinet according to claim 1, wherein each control unit is a control drawer, movable in the first or second functional area between three main positions:
an operating position of the control drawer, wherein the control drawer is configured to be connected to the electrical load and wherein the control drawer is connected to a communication module of the control cabinet,
a test position of the control drawer, wherein the control drawer is configured not to be connected to the electrical load and wherein the control drawer is connected to the communication module, and
a disconnected position of the control drawer, wherein the control drawer is configured not to be connected to the electrical load and wherein the control drawer is not connected to the communication module.

5. The electrical connection cabinet according to claim 4, wherein each control drawer comprises a lateral wall carrying a movable lateral contact configured to allow data exchange between the control drawer and the communication module, the movable lateral contact being fixed relative to the communication module when the control drawer is moved between its operating position and its test position, and wherein the lateral wall and the movable lateral contact of the electromechanical units, on the one hand, and of the electronic units, on the other hand, are identical.

6. The electrical connection cabinet according to claim 4, wherein each control drawer comprises a position detector, configured to detect whether the control drawer is in the operating position, in the test position or in the disconnected position, and a locking system, configured to lock the control drawer in the operating position or in the test position, and wherein the position detector and the locking mechanism of the electromechanical units are identical respectively to the position detector and the locking mechanism of the electronic units.

7. The electrical connection cabinet according to claim 1, wherein the magnetic type protection device of each electromechanical unit comprises an electromechanical relay, configured to cut off the power supply to the controlled switch of the electromechanical unit in case of a short circuit occurring in the electrical load connected to the electromechanical unit, this cutoff taking place in a time greater than 5 ms.

8. The electrical connection cabinet according to claim 1, wherein the common protection device of the second functional zone is of a hybrid type and comprises:
a semiconductor, configured to detect a short circuit occurring at an electrical load connected to one of the electronic units of the second functional zone, or at one of the electronic units, and
an electromechanical protection element, configured to cut off the power supply to the electronic units of the second functional zone, this cutoff taking place in a time of less than 500 μs after detection of the short-circuit.

9. The electrical connection cabinet according to claim 1, wherein a front part of each electromechanical unit comprises a mechanical switch controlling switching between an open state and a closed state of the magnetic type protection device of the electromechanical unit, configured to be actuated by a user, and wherein a front face of the common protection device comprises a mechanical switch controlling switching between an open state and a closed state of the common protection device, configured to be actuated by a user.

10. The electrical connection cabinet according to claim 1, wherein the electrical connection cabinet comprises at least two functional modules, each functional module comprising:
either at least one electromechanical unit, or at least two electronic units,
if the functional module comprises electronic units, a common protection device,
a data bus section, connected to all the control units of the functional module,
as many connection modules as control units, each connection module being configured to connect an electrical load to a control unit,
as many input/output modules as there are control units, each input/output module being configured to connect the data bus section to a control unit and to the electrical load connected to this control unit, and to allow the exchange of operating data between said electrical load, on the one hand, and said control unit and the data bus section, on the other hand, and
a support structure, to which each control unit, the data bus section, each connection module, each input/output module and, if applicable, the common protection device are fixed,
wherein each functional area accommodates a functional module,
wherein the data bus sections of all the function modules are connected to each other and to a communication module of the electrical cabinet, and
wherein the data bus section, the connection modules and the input/output modules of the functional modules comprising one or more electromechanical units, on the one hand, and the functional modules comprising one or more electronic units, on the other hand, are identical.

11. The electrical connection cabinet according to claim 3, where each electromechanical unit further comprises an enlargement piece, arranged on one side of the rear base of the electromechanical unit, so that a sum of the width of the rear base of the electromechanical units and a width of the enlargement piece is equal to the width of the electromechanical units.
